(19) United States
(12) Patent Application Publication
(10) Pub. No.: US 2019/0039554 A1
(43) Pub. Date: Feb. 7, 2019

(54) METHOD FOR PRODUCING AN AIRBAG, AND AIRBAG

(71) Applicant: TRW AUTOMITIVE GMBH, Alfdorf (DE)

(72) Inventor: Anton Fischer, Schechingen-Leinweiler (DE)

(21) Appl. No.: 16/077,084

(22) PCT Filed: Jan. 24, 2017
(86) PCT No.: PCT/EP2017/051350

§ 371 Date: Aug. 10, 2018

(30) Foreign Application Priority Data
Feb. 11, 2016 (DE) 10 2016 001 505.5

(51) Int. Cl. B60R 21/232; B60R 21/231; B60R 21/235

(52) U.S. Cl. CPC B60R 21/232; B60R 21/23138; B60R 2021/23538; B60R 2021/23509; B60R 21/235

(57) ABSTRACT

A method of manufacturing an airbag (32), especially a side airbag, for a vehicle occupant restraint system comprises the following steps of: manufacturing a textile airbag cushion (11), especially from at least one textile pre-cut (12) by joining one of more edge portions (13) by sewing; feeding the airbag cushion (11) to a sewing machine (10); making available at least one strip-shaped textile fabric (14); cutting the strip-shaped textile fabric (14) to length for forming a tab (20) which serves for later vehicle-side fastening of the airbag (32); feeding the tab (20) to the sewing machine (10) in an automated manner and attaching the tab (20) to the airbag cushion (11) by the sewing machine (10). Moreover, an airbag (32) is described comprising a textile airbag cushion (11) and at least one tab (20) for vehicle-side fastening of the airbag (32), wherein the at least one tab (20) consists of strip-shaped textile fabric (14) and is attached to the airbag cushion (11) by sewing.

### RELATED APPLICATIONS

This application corresponds to PCT/EP2017/051350, filed Jan. 24, 2017, which claims the benefit of German Application No. 10 2016 001 505.5, filed Feb. 11, 2016, the subject matter of which are incorporated herein by reference in their entirety.

### BACKGROUND OF THE INVENTION

The invention relates to a method of manufacturing an airbag, especially a side airbag, for a vehicle occupant restraint system. Furthermore, the invention relates to an airbag, especially a side airbag, for a vehicle occupant restraint system comprising a textile airbag cushion which is formed especially from at least one textile pre-cut by joining one or more edge portions by sewing and comprising at least one tab for vehicle-side fastening of the airbag.

Airbags, especially large-area window bags, are installed in vehicle occupant restraint systems in a folded or rolled state along the roof rail so that they can be stored in a space-saving manner and in the event of release have a defined expansion. Accordingly, the airbags folded or rolled to form an airbag package have to be safely retained. For this purpose, the upper portion of the airbag in the mounted state is usually provided with plural tabs by which it is fixed to the vehicle via appropriate fastening devices.

In currently common airbags the tabs frequently are in the form of an integral part of the airbag pre-cut and, where necessary, are manually reinforced by reinforcing layers cut before. Moreover, it is known to completely attach the tabs as the airbag pre-cuts then may be nested more efficiently on the textile fabric from which they are cut. In this case, the tabs are separately and completely cut out of the textile fabric, are manually arranged at the intended airbag position and are attached thereto by sewing.

Said known methods are comparatively complicated.

### SUMMARY OF THE INVENTION

Therefore, it is the object of the invention to provide a method of manufacturing an airbag and, resp., to provide an airbag which excels by reduced manufacturing time while being of high quality.

In order to achieve this object, a method of the afore-mentioned type provides the following steps of:
a) manufacturing a textile airbag cushion, especially from at least one textile pre-cut by joining one or more edge portions by sewing;
b) feeding the airbag cushion to a sewing machine;
c) providing at least one strip-shaped textile fabric;
d) cutting the strip-shaped textile fabric to length for forming a tab which serves for the later vehicle-side fastening of the airbag;
e) feeding the tab to the sewing machine in an automated manner; and
f) attaching the tab to the airbag cushion by the sewing machine.

The method according to the invention thus provides to use strip-shaped textile fabric which already has the desired width of the finished tab for forming the tabs, thus allowing a lateral pre-cut for forming the tab to be omitted. In particular, to this end pre-tailored fabric strip is used the longitudinal edges of which are finished by weaving, i.e. which are free from cut edges. The strip merely is cut to the required length. In this way and by automated feeding of the tab to the sewing machine, with the provision of the tab being integrated in the sewing process, significantly shorter process time will be achieved than in prior art. In addition, the use of strip material is definitely less expensive than manual cutting of specific tabs out of a flat textile fabric.

It is pointed out that the afore-mentioned vehicle-side fastening may also be indirect, such as by fixing, e.g. sewing, the airbag to an airbag module housing which in turn is connected to the vehicle body. It is further noted that the given method steps need not necessarily be carried out in the given order; for example, feeding of the airbag cushion to the sewing machine may take place only after cutting the strip-shaped textile fabric to length.

Preferably, at least the steps c) to f) are automated. In this way, airbags of constantly high quality can be manufactured as the risk of confusion of the tab pre-cuts as well as faulty positioning thereof is almost excluded due to the automated provision. In addition, short process times can be achieved.

An especially easy handling is achieved when the strip-shaped textile fabric is made available on one or more rolls.

Cutting to length may be carried out by means of a punching knife and/or a hot knife and/or a laser.

According to a preferred embodiment, at least one retaining hole is introduced to the tab, especially wherein the at least one retaining hole is introduced prior to feeding the tab to the sewing machine or in parallel to attaching the tab. In said retaining hole for example a vehicle-side fastening element may engage so as to safely fix the airbag to the vehicle.

In order to enable exact manufacture of the retaining holes, preferably the tab is fixed in a clamping device when the at least one retaining hole is introduced. In this way, the tab is prevented from inadvertently getting out of place.

The at least one retaining hole may also be introduced by means of a punching knife and/or a hot knife and/or a laser.

Of preference, the strip-shaped textile fabric is folded at least once in an automated manner for forming the tab. Advantageously the fold is arranged at the end of the tab facing away from the airbag cushion, which increases the bearing strength of the retaining hole being under tensile stress upon deployment of the airbag.

Preferably, the airbag cushion includes plural tab positions which show a standardized fitting geometry. Hence, a kind of standard airbag-tab interface is provided so that the process times can be further reduced.

According to a preferred embodiment, the sewing machine is a CNC machine. In this way, the required seams can be automatically produced with high precision and very quickly.

In order to increase the tear strength of the tab especially at the strongly loaded points, at least one bar tack can be produced when attaching the tab by sewing to the airbag cushion.

According to a second aspect of the invention, an airbag of the type mentioned in the beginning is provided in which the at least one tab is made from strip-shaped textile fabric and is attached to the airbag cushion by sewing. In this way, the process times can be significantly reduced as compared to the individual pre-cut of the tabs of textile fabric.

Preferably, the tab is multi-layered, especially with the airbag cushion being interposed between two layers of the tab. Hence the tab includes at least two layers which “encompass” the airbag cushion, thus allowing to achieve especially high stability.

The tab may include at least one folded strip-shaped textile fabric, which increases its tear strength in the case of tensile stress, especially for a retaining hole introduced to the tab.

Of preference, the tab includes at least one bar tack so as to increase the points loaded most strongly by the tensile stresses occurring upon deployment of the airbag. Preferably, in the longitudinal direction of the tab on both sides of a possibly present retaining hole a respective bar tack, i.e. a reinforcing seam is provided.

The strip material of the tabs thus may be advantageously adapted specifically to the characteristics of the fastening. In the case of woven strip material, a thread material different from that of the airbag may be used. Especially, the weaving density or the thread size may be different from that of the airbag.

Moreover, all developments and advantages mentioned with reference to the method according to the invention are applicable analogously to the airbag according to the invention and vice versa.

### BRIEF DESCRIPTION OF THE DRAWINGS

Further features and advantages will be resulting from the following description of a preferred embodiment by way of the enclosed drawings, wherein:

FIG. 1 shows a schematic perspective view of a sewing machine by which the method according to the invention is carried out;

FIG. 2 shows a perspective view of a feeding unit for tabs which is used in the sewing machine from FIGS. 1; and

FIG. 3 shows a detailed view of an airbag according to the invention which was manufactured by the method according to the invention.

### DESCRIPTION

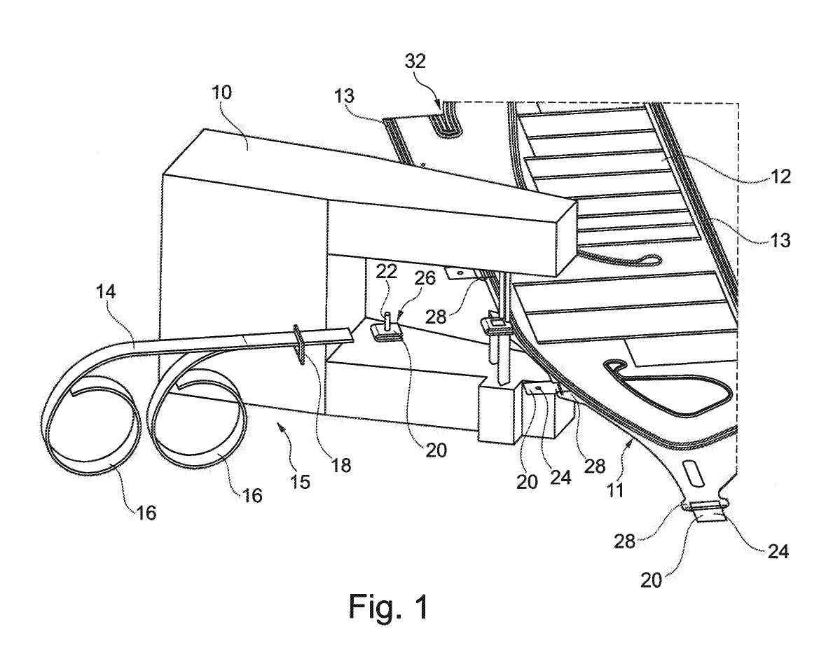

FIG. 1 schematically shows a structure for carrying out the method according to the invention. It comprises a sewing machine 10 which is especially a CNC machine. A previously fabricated textile airbag cushion 11 which is especially made from one or more textile pre-cuts 12 by joining one or more edge portions 13 by sewing is fed to the sewing machine. Alternatively, the airbag cushion 11 may also be integrally woven. The airbag cushion 11 is e.g. a large-area window bag covering the side windows of a vehicle.

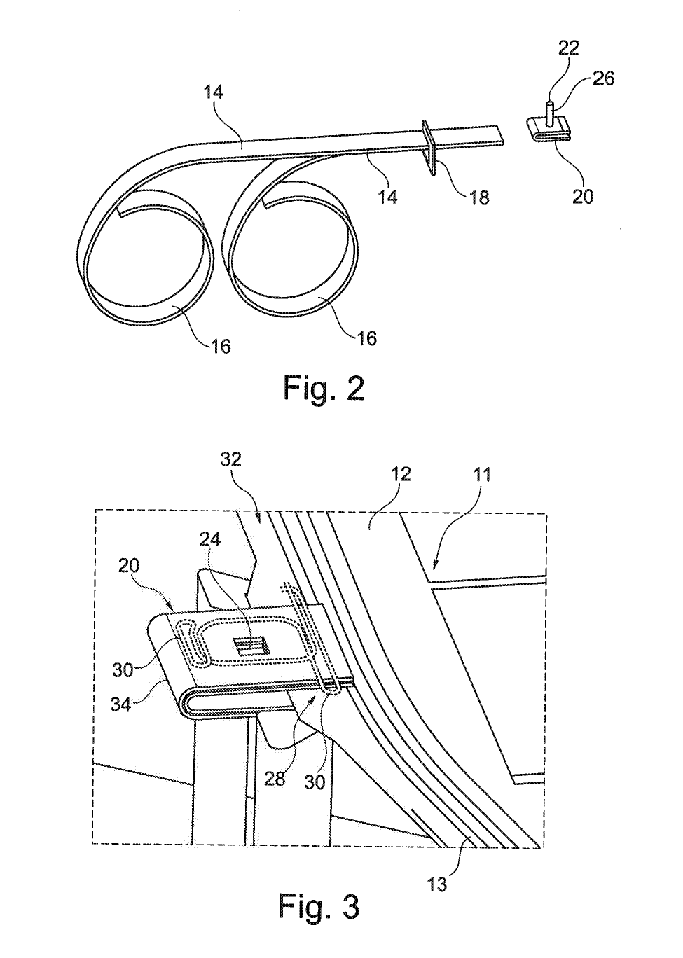

Furthermore, a schematically illustrated automatic feeding unit 15 is provided which is shown further enlarged in FIG. 2 and includes a strip-shaped textile fabric 14 which is made available on two rolls 16. The rolls 16 are arranged directly in series in the feeding unit 15 so that when the strip-shaped textile fabric 14 is unwound two fabric layers are directly superposed.

The feeding unit 15 moreover comprises a cutting device 18 which may be a punching knife, a hot knife or a laser. The cutting device 18 is used to cut the strip-shaped textile fabric 14 to a desired length and to subsequently fold it once in an automated manner so as to form a tab 20.

After that, by means of a piercing device 22, which again may be a punching knife, a hot knife or a laser, at least one retaining hole 24 is introduced to the folded tab 20, with the tab 20 being fixed in a clamping device 26.

Upon request, the tab 20 prepared in this way is fed in an automated manner by the feeding unit 15 to the sewing machine 10 which attaches the tab 20 at a desired tab position 28 to the airbag cushion 11 appropriately positioned already before.

When attaching the tab 20 to the airbag cushion 11 by sewing, bar tacks 30 are produced so as to increase the stability of the tab 20 and, resp., of the seams. As is evident from FIG. 1, the airbag cushion 11 includes plural tab positions 28 which have a standardized fitting geometry and at which the afore-described method steps are repeated.

FIG. 3 illustrates a cutout of the finished airbag 32 which is formed of the airbag cushion 11 and plural tabs 20 and which is a side airbag for a vehicle occupant restraint system (cf. also FIG. 1).

The tabs 20 serving for vehicle-side fastening of the airbag 32 are multi-layered, four-layer in this case, wherein the airbag cushion 11 is interposed between two layers of the tabs 20 such that on each side of the airbag cushion 11 two layers of the strip-shaped textile fabric 14 are located.

The fold 34 of the once-folded strip-shaped textile fabric 14 is arranged at the outwardly pointing end of the tab 20 facing away from the airbag cushion 11 so as to increase the bearing strength of the retaining hole 24 which upon deployment of the airbag 32 is under tensile stress.

The bar tacks 30 are disposed in the longitudinal direction of the tab 20 on both sides of the retaining hole 24.

The method according to the invention enables the tabs 20 to be quickly attached to the airbag cushion 11 by sewing in an automated manner, as especially the steps of providing the strip-shaped textile fabric 14, cutting the strip-shaped textile fabric 14 to length, folding the strip-shaped textile fabric 14, feeding the tab 20 to the sewing machine 10 as well as attaching the tab 20 to the airbag cushion 11 by the sewing machine 10 are carried out in an automated manner. Accordingly, process times of few seconds for each tab 20 are possible.

1-15. (canceled)

16. A method of manufacturing an airbag (32), especially a side airbag, for a vehicle occupant restraint system, wherein by the following steps of:
a) manufacturing a textile airbag cushion (11), especially from at least one textile pre-cut (12) by joining one or more edge portions (13) by sewing;
b) feeding the airbag cushion (11) to a sewing machine (10);
c) providing at least one strip-shaped textile fabric (14);
d) cutting the strip-shaped textile fabric (14) to length for forming a tab (20) which serves for later vehicle-side fastening of the airbag (32);
e) feeding the tab (20) to the sewing machine (10) in an automated manner; and
f) attaching the tab (20) to the airbag cushion (11) by the sewing machine (10).

17. The method according to claim 16, wherein at least the steps c) to f) are carried out in an automated manner.

18. The method according to claim 16, wherein the strip-shaped textile fabric (14) is made available on one or more rolls (16).

19. The method according to claim 16, wherein cutting to length is carried out by means of a punching knife and/or a hot knife and/or a laser.

20. The method according to claim 16, wherein at least one retaining hole (24) is introduced to the tab (20).

21. The method according to claim 20, wherein the at least one retaining hole (24) is introduced prior to feeding the tab (20) to the sewing machine (10) or in parallel to attaching the tab (20) by sewing.

22. The method according to claim 20, wherein the tab (20) is fixed in a clamping device (26) when the at least one retaining hole (24) is introduced.

23. The method according to claim 20, wherein the at least one retaining hole (24) is introduced by means of a punching knife and/or a hot knife and/or a laser.

24. The method according to claim 16, wherein the strip-shaped textile fabric (14) is folded at least once in an automated manner for forming the tab (20).

25. The method according to claim 16, wherein the airbag cushion (11) includes plural tab positions (28) which show a standardized fitting geometry.

26. The method according to claim 16, wherein the sewing machine (10) is a CNC machine.

27. The method according claim 16, wherein when attaching the tab (20) to the airbag cushion (22) by sewing at least one bar tack (30) is produced.

28. An airbag, especially a side airbag, for a vehicle occupant restraint system, comprising:
a textile airbag cushion (11) which is made especially from at least one textile pre-cut (12) by joining one or more edge portions (13) by sewing, and
at least one tab (20) for vehicle-side fastening of the airbag (32),
wherein the at least one tab (20) consists of a strip-shaped textile fabric (14) and is attached to the airbag cushion (11) by sewing.

29. The airbag according to claim 28, wherein the tab (20) is multi-layered.

30. The airbag according to claim 28, wherein the airbag cushion (11) is interposed between two layers of the tab (20).

31. The airbag according to claim 28, wherein the tab (20) includes at least one folded strip-shaped textile fabric (14).

32. The airbag according to claim 28, wherein the tab (20) includes at least one bar tack (30
